(19) United States
(12) Patent Application Publication
(10) Pub. No.: US 2022/0218550 A1
(43) Pub. Date: Jul. 14, 2022

(54) APPARATUS FOR THE TREATMENT OR PREVENTION OF OSTEOPENIA AND OSTEOPOROSIS, STIMULATING BONE GROWTH, PRESERVING OR IMPROVING BONE MINERAL DENSITY, AND INHIBITING ADIPOGENESIS

(71) Applicants: Nikhil VISWANATHAN, San Francisco, CA (US); Alexander VERGARA, San Francisco, CA (US); Daniel R. BURNETT, San Francisco, CA (US)

(72) Inventors: Nikhil VISWANATHAN, San Francisco, CA (US); Alexander VERGARA, San Francisco, CA (US); Daniel R. BURNETT, San Francisco, CA (US)

(21) Appl. No.: 17/657,710

(22) Filed: Apr. 1, 2022

Related U.S. Application Data
(63) Continuation of application No. PCT/US2020/056837, filed on Oct. 22, 2020.
(60) Provisional application No. 62/924,302, filed on Oct. 22, 2019.

(51) Int. Cl. A61H 1/00; A61H 23/02

(52) U.S. Cl. CPC A61H 1/00; A61H 23/02; A61H 2201/5007; A61H 2201/165; A61H 2201/5071; A61H 2205/088; A61H 2201/0184; A61H 2201/5084

(57) ABSTRACT

Apparatus for the treatment or prevention of osteopenia and osteoporosis, stimulating bone growth, preserving or improving bone mineral density, and inhibiting adipogenesis are described herein.

### CROSS-REFERENCE TO RELATED APPLICATIONS

This application is a continuation of PCT/US2020/056837 filed Oct. 22, 2020, which claims the benefit of priority to U.S. Prov App. 62/924,302 filed Oct. 22, 2019, which is incorporated herein by reference in its entirety.

### FIELD OF THE INVENTION

The present invention relates generally to the stimulation of bone growth, healing of bone tissue, and treatment and prevention of osteopenia, osteoporosis, cartilage and chronic back pain, and to preserving or improving bone mineral density, and to inhibiting adipogenesis particularly by the application of repeated mechanical loading to bone tissue.

### INCORPORATION BY REFERENCE

All publications and patent applications mentioned in this specification are herein incorporated by reference to the same extent as if each such individual publication or patent application were specifically and individually indicated to be so incorporated by reference.

### BACKGROUND OF THE INVENTION

Osteopenia is a highly common skeletal condition with accelerated loss of bone mass leading to osteoporosis if not treated. Characterized by below normal bone mineral density (BMD, osteopenia is defined by a BMD T-score of −1.0 to −2.49), osteopenia affects 43 million Americans. If BMD loss is not mitigated, patients become osteoporotic (as defined by a BMD T-score of ≤2.5) with risk of serious clinical consequences due to fractures. Approximately 50% of women and 25% of men aged 50 years and older will have an osteoporosis-related bone fracture, accounting for $19 billion in healthcare costs every year. In addition, while women with osteoporosis are at the greatest risk of fracture, a greater number of bone fractures occur in osteopenic women due to the higher prevalence of osteopenia. Hip and spine fractures are two of the most common types of osteoporosis-related fractures, with over 300,000 hip fractures and over 700,000 spine fractures per year in the United States. Bone fractures, particularly of the proximal femur, result in disability, with significant impact on the capacity to live independently. Furthermore, mortality associated with osteoporotic fractures ranges from 15 to 30%. Mitigating continued bone loss in the early stages of low bone mass is of paramount importance to prevent the onset and devastating sequelae associated with osteoporosis.

Despite the high prevalence of osteopenia, few treatment options exist. Current clinical practice guidelines for patients with osteopenia include initiating both dietary modifications (e.g. increased calcium and vitamin D intake) and discussing the importance of high impact exercise. Recent evidence has shown that calcium and vitamin D alone do not decrease fracture risk. While the combination of diet/supplements and exercise are effective in maintaining bone mass, daily compliance with weight-bearing exercise that effectively stimulates bone cells to mitigate bone loss is low in aging populations. In addition to issues with compliance, vigorous aerobic or strength training exercises may increase risk of injury in susceptible individuals. Alternatively, medication is offered to treat bone loss associated with osteoporosis. Bisphosphonates and RANK-L inhibitors, which inhibit osteoclastic bone resorption or osteoclast maturation, respectively, are widely prescribed and effective at limiting bone mass loss. However, there are concerns that prolonged use of these drugs increases the risk of serious adverse events, including osteonecrosis of the jaw and atypical subtrochanteric and diaphyseal femur fractures. Accordingly, these pharmaceuticals are typically not prescribed until bone mass reaches osteoporotic, or near-osteoporotic, levels when their antifracture benefits considerably outweigh their potential for harm. In addition, due to these more serious side effects and less serious, but still inconvenient, side effects, (e.g. abdominal pain, nausea), 22-82% of patients discontinue pharmaceutical use within 12 months of initiating treatment. Therefore, there remains a need for a safe, effective, and convenient treatment for osteopenia that can prevent the early progression of bone loss prior to a patient reaching the osteoporotic state.

Dynamic mechanical loading of the skeleton is a key factor in the body's regulation of bone mass. Bone cells, both osteoblasts and osteoclasts, have been shown to respond to many forms of mechanical loading. Mechanical vibration has been shown to have stimulatory effects at the bone tissue level in both animal and clinical studies Animal studies in rat, turkey, and sheep models have shown that vibration at 30-90 Hz (hertz) is a potent stimulator of bone formation in long bones of the appendicular skeleton. Clinically, whole body vibration (WBV) platforms have been developed to apply vibration to the body through a vibrating platform that the individual stands on.

Despite promising results with WBV platforms, these devices have two key drawbacks. First, current WBV platforms require the user to stand on the platform for at least 20 minutes per day and at least three days per week. This regimen can be a major obstacle to treatment compliance and, accordingly, treatment effectiveness. Accordingly, a more convenient vibration therapy could have improved outcomes.

A second drawback of current WBV platforms is the trade-off between safe and effective vibration levels. WBV platforms rely on vibration being transferred from the feet to the hips and spine. It has been shown that the vibration magnitude dampens as it is transmitted up the skeleton. Therefore, vibration at the platform needs to be higher than the therapeutic level at the hips and spine. However, there are safety concerns with regular exposure to higher WBV levels. While the relationships between vibration magnitude, duration/frequency of exposure, and safety are hypothesized, they are poorly understood and generally unproven, particularly for exposure under 4 hr/day. ISO 2631-1 (International Standard for Mechanical vibration and shock—Evaluation of human exposure to whole-body vibration) is focused on providing guidelines for safe levels of vibration transmitted through the body via the supporting structure when the individual is standing or sitting for 4-8 hr/day (e.g. heavy machine operators, factory workers). Nonetheless, ISO 2631-1 includes guidelines for extrapolating to shorter periods of exposure. Taking these into account, while effective, high vibration levels may be unsafe in the long-term. Accordingly, a more direct means of transmitting vibration to the hips and spine that allows for an overall lower magnitude of vibration to the individual, may provide a safe and effective therapy for treating low bone mass.

Additionally, a portable device, vs. a stationary device may be desired.

### SUMMARY OF THE INVENTION

A wearable vibration device provides a novel method and apparatus for the stimulation of bone growth, healing of bone tissue, and prevention of osteoporosis, osteopenia, and chronic back pain. The wearable vibration device may maintain or promote bone-tissue growth, may prevent the onset of osteoporosis, cartilage and may treat chronic back pain.

In some embodiments of the wearable vibration device, the device provides effective treatment by targeted application of oscillating mechanical loads to the hip and spine of a user. In some embodiments, the device is worn over, and the vibration is focused on, the sacrum.

The wearable vibration device allows for delivery of WBV stimulus in side-to-side, front-to-back, and/or in inferior-superior directions. This flexibility in the delivery system allows for better targeting of the hips and spine in the treatment of osteoporosis and loss of BMD. More specifically in one variation, one or more vibrating elements may be positioned against the patient's body via one or more securing mechanisms, respectively, which are configured to position the vibrating elements in a direction lateral to the individual's body such that the mechanical loads are applied laterally to the patient. The fit of the device may be monitored by various sensors and the vibrational energy may be adjusted to compensate for less than optimal fit.

In addition, a wearable device provides the user with more ambulatory options than a stationary device.

One variation of a vibration apparatus for treating a subject may generally comprise an actuator configured to generate vibrational energy, a securing mechanism for positioning the actuator upon the body of the subject while maintaining portability such that the vibrational energy generated by the actuator is directed into an area of the body of the subject to be treated, and a controller in communication with the actuator, wherein the controller is programmed to determine an exposure level of the vibrational energy to the area of the body for comparison against a maximum exposure level such that the exposure level is limited by the maximum exposure level within a predetermined period of time.

Another variation of the vibration apparatus may generally comprise an actuator configured to generate vibrational energy and a securing mechanism for positioning the actuator upon the body of the subject while maintaining portability such that the vibrational energy generated by the actuator is directed into an area of the body of the subject to be treated. A first accelerometer may be positioned in proximity to the area of the body of the subject and configured to detect a resultant vibrational energy transmitted into the area of the body of the subject. Additionally, a controller may be in communication with the actuator and the first accelerometer, wherein the controller is programmed to receive a signal indicative of the resultant vibrational energy from the first accelerometer and automatically calibrate the actuator to adjust the generated vibrational energy until the resultant vibrational energy is within a predetermined range.

One variation for a method for treating a subject may generally comprise generating vibrational energy from an actuator such that the vibrational energy is directed into an area of a body of the subject while maintaining portability of the actuator, monitoring the vibrational energy transmitted into the area of the body via a controller, determining an exposure level via the controller of the vibrational energy transmitted into the area of the body for comparison against a maximum exposure level such that the exposure level is limited by the maximum exposure level within a predetermined period of time, and transmitting the vibrational energy into the area of the body to be within the maximum exposure level.

Another method for treating the subject may generally comprise generating vibrational energy from an actuator such that the vibrational energy is directed into an area of a body of the subject while maintaining portability of the actuator, monitoring a resultant vibrational energy transmitted into the area of the body of the subject via a first accelerometer positioned in proximity to the area of the body, wherein the first accelerometer and the actuator are in communication with a controller, and automatically calibrating the actuator via the controller by adjusting the vibrational energy until the resultant vibrational energy is within a predetermined range.

### BRIEF DESCRIPTION OF THE DRAWINGS

FIG. 1 shows an embodiment of the wearable vibration device.

FIGS. 2A-B show various views of an embodiment of the wearable vibration device.

FIG. 3 shows the top view of an embodiment of the wearable vibration device.

FIGS. 4A-C show various views of an embodiment of the wearable vibration device.

FIGS. 5A-C show various views of an embodiment of the wearable vibration device.

FIG. 6 shows a logical diagram of the function of an embodiment of the wearable vibration device.

FIG. 7 shows a diagram of the various components of an embodiment of the wearable vibration device.

FIG. 8 shows an embodiment of the vibration device which is in the form of a seat covering.

FIG. 9 shows an embodiment of the vibration device which includes a foam platform with protuberance.

FIGS. 10A-C show different views of another embodiment of the foam platform and protuberance.

FIGS. 11A-C show different views of another embodiment of the foam platform and protuberance, along with some example dimensions in inches.

FIG. 12 shows an embodiment of the belt of the device.

FIG. 13 shows an embodiment of the vibration pack

FIG. 14 shows control logic of some embodiments as represented by a flowchart

FIG. 15 is a block diagram of a data processing system, which may be used with any embodiments of the invention.

### DETAILED DESCRIPTION OF THE INVENTION

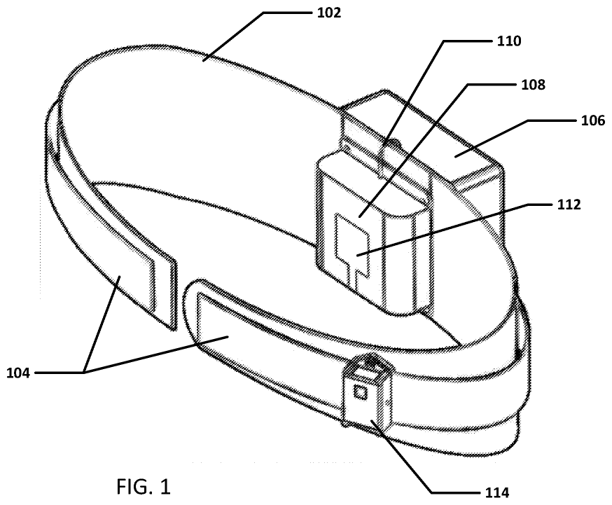

FIG. 1 shows an embodiment of the wearable vibration device. This embodiment is designed to be worn around the waist so that the vibrational energy is applied to the user's hip/spine area. In some embodiments, the device is worn so that the vibrational energy is focused on the sacrum. Band 102 may be secured to the body via securing mechanisms, or straps, 104. Container or enclosure 106 of the vibration pack may contain the vibrational motor, processor, battery, battery charger, voltage regulator, buzzer or alarm, motor sensor, thermal switch and other components and/or electronics. Container 106 is secured to band 102 and connected to pressure sensor 112 via connector 110. Dampening, or foam, block, or spacer 108 serves to direct the vibrational energy more precisely toward a certain area of the user and also to increase the comfort for the user while using the wearable vibration device. The pressure sensor may be on top of or below the foam. Accelerometer 114 monitors the vibrational forces which are transferred through the body to determine whether the fit of the wearable vibration device is correct. The accelerometer(s) may be on the inside, outside, or embedded within band 102. The accelerometer may also assess effectiveness of the application of vibrational forces to the user. Pressure sensor 112 may also serve this purpose by determining the pressure of the device against the body. The measured pressure is indicative of the fit of the device.

In some embodiments, there is more than one pressure or force sensor to sense fit. In some embodiments, there is an array of pressure/force sensors to sense fit. Using multiple sensors, fit can be assessed more precisely. For example, the controller may be able to sense if the device is situated too high, too low, too far to the left, too far to the right, too loose, too tight, or some combination of these. The controller may communicate to the user how to adjust the device to improve the fit. The controller may indicate to move the device up, down, left, right, to tighten or loosen the device.

The fit of the wearable vibration device is important to ensure proper function. For example, if the wearable vibration device is too loose or too tight on the body, the proper amount of vibrational energy may not be transferred to the bone(s), or the energy may be transferred to the wrong location, or the energy may be transferred in the wrong direction. In addition, the comfort to the user of the device may be compromised if the fit is not correct.

To ensure proper fit, the wearable vibration device may include one or more than one sensor. These sensors may include, but are not limited to: contact sensor(s), pressure sensor(s), strain gauge(s), accelerometer(s), and gyroscope(s). A sensor or sensors may be placed anywhere on the wearable vibration device, including the straps, bands, securing mechanism, motor, spacer, container etc. in some embodiments, a sensor may be physically separate from the device, but in wired or wireless communication with the controller of the device. In addition, an alarm or alarms may be included in the wearable vibration device to alert the user to adjust the fit. Various types of alarms may be used, including audible, visible, such as a blinking light, tactile, such as a pulsing of the vibrational motor, etc. The alarm may sound for a set period of time, or until the fit is improved, or both. In addition, or alternatively, the securing mechanism of the wearable vibration device may be self-adjusting based on the feedback from the fit sensor(s). This may be achieved with a motor, a thermal mechanism, a mechanical mechanism, an electrical mechanism etc.

Alternatively or additionally, if the fit is not providing the optimal vibrational energy transfer, the processor of the wearable vibration device may adjust the movement of the motor to increase or decrease the vibrational energy being transferred to the user. In this way the optimal treatment vibrational energy may be optimized automatically even if the fit changes during the treatment.

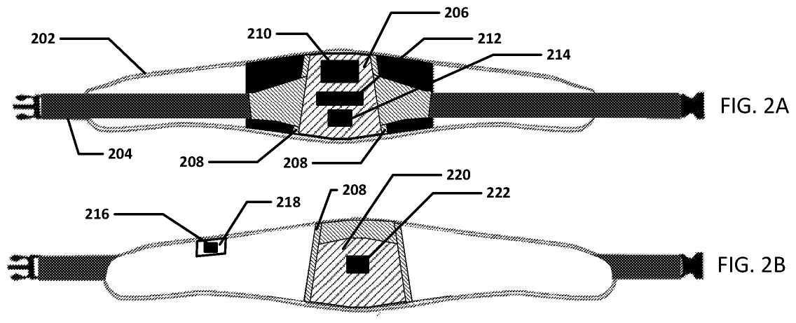

FIGS. 2A-B show two views of an embodiment of the wearable vibration device. FIG. 2A shows the side of the wearable vibration device which faces away from the user. Band 202 may be secured to the body via securing mechanisms, or straps, 204. Container, pouch, or pocket, 206 contains motor 212, electronics 210 and battery 214. Boning 208 helps hold the contents of pocket 206 securely and helps provide rigidity to the wearable vibration device.

FIG. 2B shows the side of the wearable vibration device which faces toward the user, so is in contact with the user's body. Container, pouch, or pocket 220 holds the spacer mentioned in FIG. 1. Pressure sensor 222 senses the measures the pressures caused by the vibration of the motor in pocket 206 as well as the overall tightness, or fit, of the wearable vibration device on the user's body. Pressure sensor(s) may also, or instead, be placed on other areas of the wearable vibration device. Accelerometer 216 is held in pocket, or slot, 218 and is for monitoring the fit of the wearable vibration device and/or the effectiveness of the transfer of vibrational forces to the user. One or more various sensors may be placed at various locations on the wearable vibration device to monitor the fit of the device.

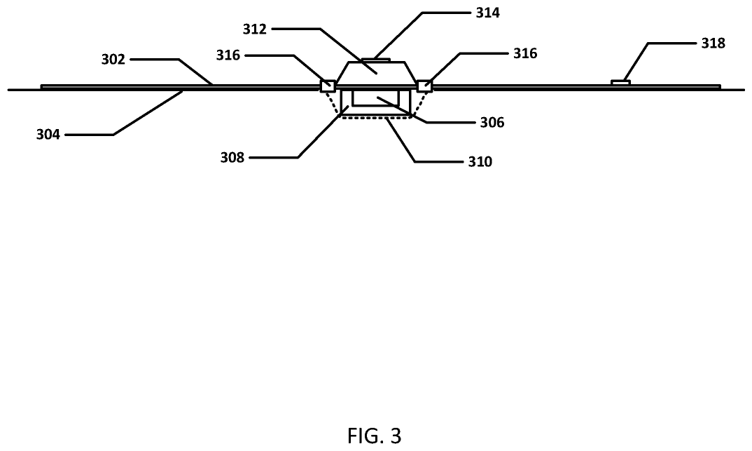

FIG. 3 shows a top view of an embodiment of the wearable vibration device. Band 302 may be secured to the body via securing mechanisms, or straps, 304. Motor 306 and other electronics and components are contained in container 308 inside pocket 310. Spacer 312 and pressure sensor 314 are on the inside of the wearable vibration device. Boning 316 helps hold the contents of pocket 310 securely and helps provide rigidity to the wearable vibration device. Accelerometer 318 aids in monitoring the fit of the wearable vibration device and/or the effectiveness of the transfer of vibrational forces to the user.

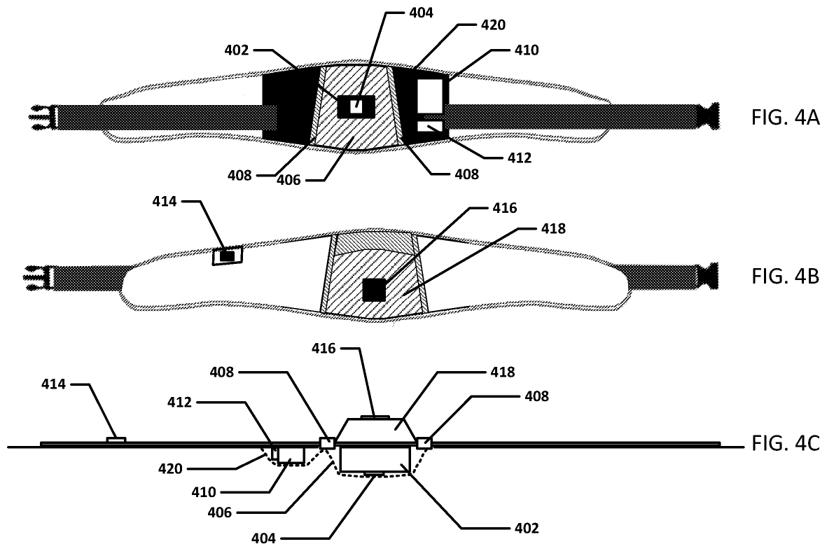

FIGS. 4A-C show various views of an embodiment of the wearable vibration device. FIG. 4A shows the side of the wearable vibration device which faces away from the user. Container, pouch, or pocket, 406 contains motor 402 and motor sensor 404. Pouch, or pocket, 420 contains electronics 410 and battery 412. Boning 408 helps hold the contents of pocket 406 securely and helps provide rigidity to the wearable vibration device. Accelerometer 414 aids in monitoring the fit of the wearable vibration device and/or the effectiveness of the transfer of vibrational forces to the user.

FIG. 4B shows the side of the wearable vibration device which faces toward the user, so is in contact with the user's body. Container, pouch, or pocket 418 holds the spacer mentioned in FIG. 1. Pressure sensor 416 senses the measures the pressures caused by the vibration of the motor in pocket 406 as well as the overall tightness of the wearable vibration device on the user's body. Pressure sensor(s) may also, or instead, be placed on other areas of the wearable vibration device. Accelerometer 414 is for monitoring the fit of the wearable vibration device and/or the effectiveness of the transfer of vibrational forces to the user.

FIG. 4C shows the bottom view of the device in FIGS. 4A and 4B.

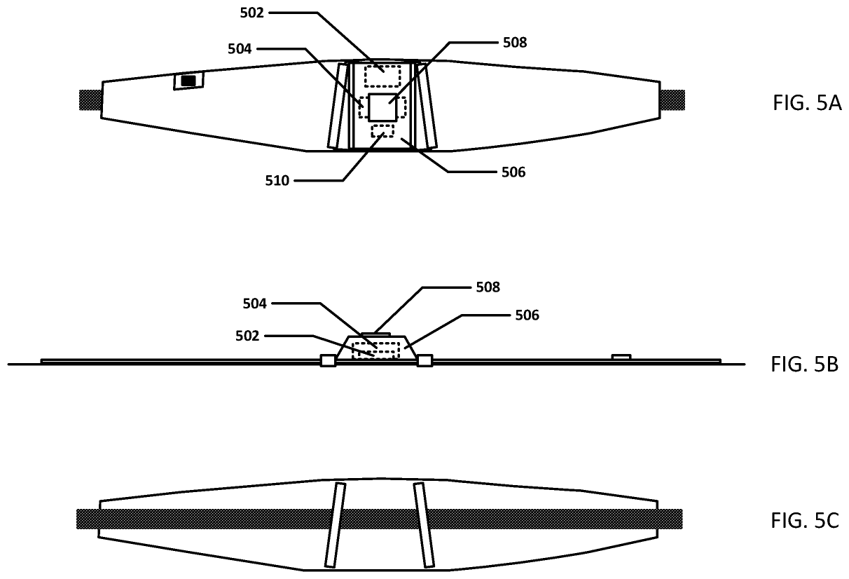

FIGS. 5A-C show various views of an embodiment of the wearable vibration device.

FIG. 5A shows the side of the wearable vibration device which faces toward the user, so is in contact with the user's body. In this embodiment spacer device 506 holds motor 504, electronics 502 and battery 510. Pressure sensor 508 is on the outside of the spacer so it is in contact with the user. Pressure sensor 508 senses the measures the pressures caused by the vibration of the motor as well as the overall tightness of the wearable vibration device on the user's body, before, during or after the motor is turned on. Pressure sensor(s) may also, or instead, be placed on other areas of the wearable vibration device. This embodiment allows for a more compact device.

FIG. 5B shows the top view of the device in FIG. 5A. FIG. 5C shows the side of the wearable vibration device which faces away from the user.

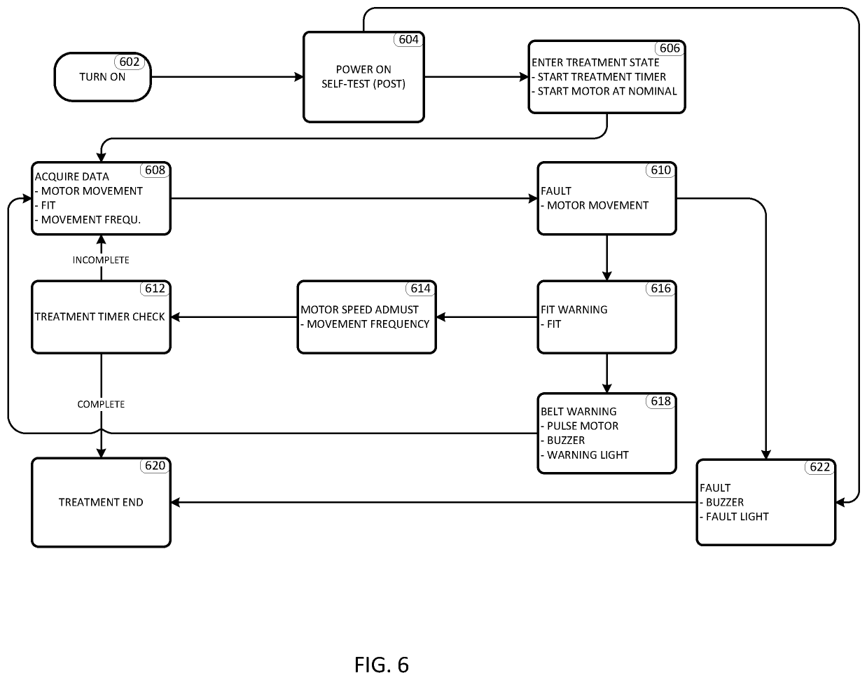

FIG. 6 shows a logical diagram of the function of an embodiment of the wearable vibration device. First, the device is turned on, represented by box 602. The processor then checks for faults, represented by box 604. Several components are checked including the battery, electronic communications, and other checks. If any fault is present, the processor moves to the fault handler box 622. For example, on startup a single fault may be enough to trigger the fault handler, however during operation, more than one fault may need to occur, either consecutively or within a certain time frame, to trigger the fault handler. If no faults are present, the processor moves on to enter the treatment state, represented by box 606. Entering the treatment state includes starting the treatment timer, starting the motor at a nominal setting, and may include other processes. During the treatment state, the processor may acquire data either intermittently, or continuously, such as motor movement, the fit of the device, and the movement frequency. This is represented by box 608. Fit may include feedback from one or more sensors, including, but not limited to contact sensor(s), pressure sensor(s), strain gauge(s), accelerometer(s), and gyroscope(s). Motor movement and motor frequency are determined by a motor sensor. It is also envisioned that fit may be assessed before the motor is turned on, either instead of, or in addition to, assessing fit after the motor is turned on.

If the motor movement is not in the appropriate range, a motor movement fault is triggered, represented by box 610. The appropriate range may be preset and may depend on the weight, height, age, sex etc. of the user, as well as the treatment type, area, time etc. The appropriate range may also be dynamically set based on the fit of the wearable vibration device and/or other factors. A fault in the motor movement may result in an audible buzzer or alarm, a visible light and/or other alarms.

If the fit is not in the appropriate or optimal range, a fit fault or warning is triggered, represented by box 616. The appropriate range for fit may be based on feedback from any of the sensors described herein. The appropriate/optimal range for fit may be set ahead of time, or may be dynamically set based on the fit of the wearable vibration device and/or other factors. The processor may check for fit on a periodic basis. For example, if the fit check returns two or more consecutive fit faults, the fit warning handler may be triggered. Fit warning handler is represented by box 618. A fault in the fit may result in a pulse alarm, which may be generated by pulsing the vibrational motor, an audible buzzer or alarm, a visible light and/or other alarms.

After hearing, feeling, seeing or otherwise perceiving a fit alarm, the user may either adjust the fit of the wearable vibration device, or the processor may adjust the motor movement as represented in box 614, or both. The frequency, amplitude and other motor parameters may be adjusted to optimize the treatment in response to the fit warning. The motor parameter adjustment may be a continual check occurring in the regular code loop. For example, if the motor frequency changes for whatever reason (fit, movement, activity, body position, time, etc) and is outside of a predetermined window away from a predetermined frequency (30 Hz for example) for a certain timer or counter: then the motor may adjust itself to correct for the error in frequency.

As treatment proceeds, the processor continually or intermittently checks the treatment timer, represented by box 612. If the treatment time is complete, the processor moves onto to box 620 and the treatment is ended. If the treatment time is incomplete, the processor of the wearable vibration device continues the treatment, and continues acquiring motor, fit, and/or other data until the treatment ends.

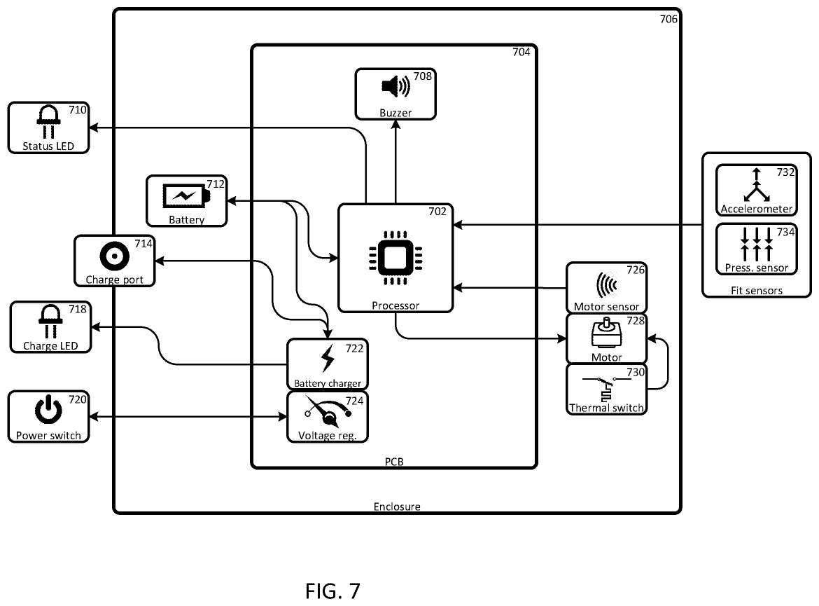

FIG. 7 shows a diagram of the various components of an embodiment of the wearable vibration device. Processor 702 includes the control electronics and is located on circuit board 704. The circuit board, along with other components, is within enclosure 706, for example, similar to enclosure 106 in FIG. 1. Also on the circuit board are buzzer 708, battery charger 722 and voltage regulator 724 linked to the battery. Inside the enclosure are also battery 712, motor 728, motor sensor 726 and thermal switch 730 linked to the motor. Charge port 714 is located at the enclosure or container wall so that it can be accessed and the battery charged.

Outside of the enclosure are other components including power switch 720, charge LED 718, status LED 710 and any fit sensor(s). Fit sensors may include, but are not limited to, contact sensor(s), pressure sensor(s) 734, strain gauge(s), accelerometer(s) 732, and gyroscope(s).

Embodiments to treat other body areas are also envisioned. For example, vibration may be delivered to the foot through a shoe or sock like device, or a device that straps, or otherwise attaches to the foot or lower limb. Vibrational stimulus delivered to the foot or lower limb may help treat osteoporosis or other ailments.

It has also been shown that vibratory noise applied to the sole of the foot may improve sensation, enhance balance, and/or reduce gait variability. The vibratory noise, or energy, may be subsensory or may be sensed by the wearer. As in other embodiments, the application of vibration may be periodic, continuous, or otherwise.

Although embodiments have been described herein, other embodiments are envisioned. For example, the wearable vibration device may be designed to be worn on other areas of the body such as the neck, back, limbs, head etc. The vibrational energy may be configured to be directed in different directions, more than one direction, alternating directions, simultaneously different directions etc. More than one vibrational motor may be present in the device, allowing for more flexibility in directing vibrational energy in terms of direction, body part, etc. the vibrational energy may change with time, increasing/decreasing amplitude, increasing/decreasing frequency, changing direction, cycling through a program, turning on and off, etc. The stimulation vibration may also incorporate different kinds of waveforms. For example, square, triangle, saw tooth, sinusoidal waveforms, etc. These different waveforms may introduce harmonics of the base frequency and may provide enhanced or additional benefits. Multiple frequencies may also be superimposed on each other in the vibrating element. Multiple vibrational motors may be worn on different parts of the body. Multiple wearable vibration devices may be worn. Multiple vibrational motors may be used to partially or fully cancel, augment, or change the vibrational energy applied to the user. Vibrational energy may be transferred transcutaneously to an implanted metal plate. For example, the vibration device may be placed on the outer surface of the leg to vibrate a metal bone plate within the leg to reduce bone necrosis around the plate. This embodiment of the device may be used periodically, possibly once per day or once per week or once per month to reduce necrosis of the bone.

Embodiments of the wearable vibration device may be used for SI (sacroiliac) joint syndrome, SI joint arthrosis, SI joint instability, SI joint blockage, Myalgia and tendopathia in pelvic region, Pelvic ring instability, In the case of structural disturbance following lumbar spinal fusion, For prophylaxis of relapsing SI joint blockages and myotendopathia (M. rectus abdominis, M. piriformis adduktoren), Symphysis rupture and relaxation, back pain, cartilage strengthening, as well as other conditions.

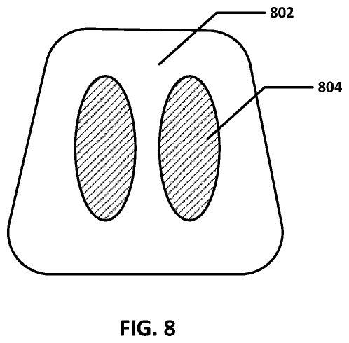

FIG. 8 shows an embodiment of the vibration device which is in the form of a seat covering or pad. This embodiment includes the pad 802 itself, which may incorporate layers of foam or other padding, and plates 804 which are connected to the controller and vibrate. The plates may be metal, polymer, or any other suitable material. Preferably, the plates are rigid or semi-rigid. The plates may be shaped in a way to “cup” the bones of the buttocks to maximize the transmission of vibrational energy from the plates to the bones. The controller may be incorporated into the pad or may be a separate device, which controls the plates wirelessly or via wired connection. The user places the seat pad/covering on a chair, or other surface, and sits on top of the seat pad, so that the area of the buttock which includes the protruding bones that make up the ischium is in contact, or near contact with the plates. The plates may have a padded covering between the plate and the user. Vibrational energy is transmitted from the plates to the ischium and to the skeleton in general to transmit the vibrational energy to the lower back and hip area. The vibrational energy may be horizontal, vertical or both. In this embodiment, the weight of the user helps make sure the device is “fit” appropriately against the body. However, like other embodiments accelerometers may be used to assess “fit”. In some embodiments, the accelerometer reading may be correlated with treatment results to determine preferred accelerometer readings. The controller may control the vibration and force of the vibration device to optimize the accelerometer readings. A strap, or other connector, may be used to help secure the pad close to the body of the user.

The vibration device may also be in the form of a back pad, similar to the one shown in FIG. 8, but meant to be placed against the back of a chair with the plate areas of the device in contact with the hip bones, for example, the iliac. In this embodiment, a strap may be included to increase the proximity of the vibration device to the hip bone area.

The vibration device may also be in the form of a weighted lap pad, with vibrational plate areas in proximity to the iliac crest areas of the hip bones.

Vibrational treatments may also be performed in forces and frequencies to treat constipation, and other digestion disorders.

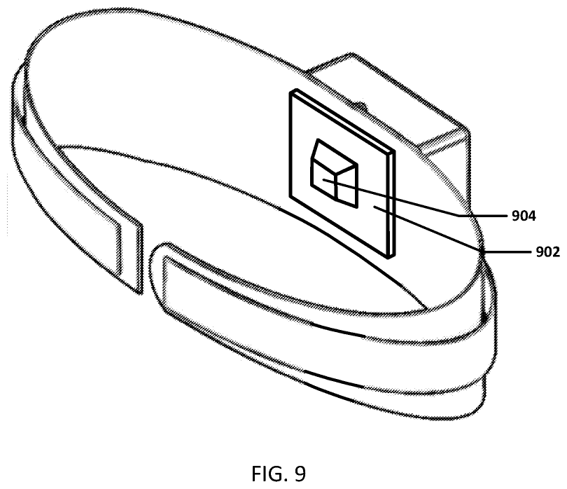

FIG. 9 shows an embodiment of the vibration device which includes foam platform 902 with foam protuberance 904. The protuberance is shown here as a tapered square, but it may be rectangular, circular, oval, rounded, etc. The protuberance may be tapered or not tapered. The protuberance may take up a small portion, a large portion, or essentially all of the surface area of the platform. The foam platform and protuberance are designed to increase comfort of the user, increase the likelihood of proper placement over the sacrum, and allow transference of the vibrational energy from the motor to the sacrum of the patient. The platform and/or protuberance may be made from a high density polymer foam, such as a crosslinked poly ethylene foam. An example is provided below:

### Crosslinked PE Foam

| PROPERTY | AVE VALUE | UNIT |
|---|---|---|
| Density | 35-42 | Kg/m³ |
| Bun Size | 2000 × 1000 | |
| Thickness | 0.5-100 | mm |
| Hardness | 18-23 | Asker C |
| Tensile Strength | 252 | Kpa |
| Elongation at Break | 220 | % |
| Tear Strength | 1.75 | kN/m |
| Temperature Range | −50/80 | ° C. |
| Water Absorption | 3 | % |
| Thermal Conductivity | 0.04 | W/mK |
| 25% Compression Deflection | 45 | Kpa |
| 50% Compression Set | ≤20 | % |

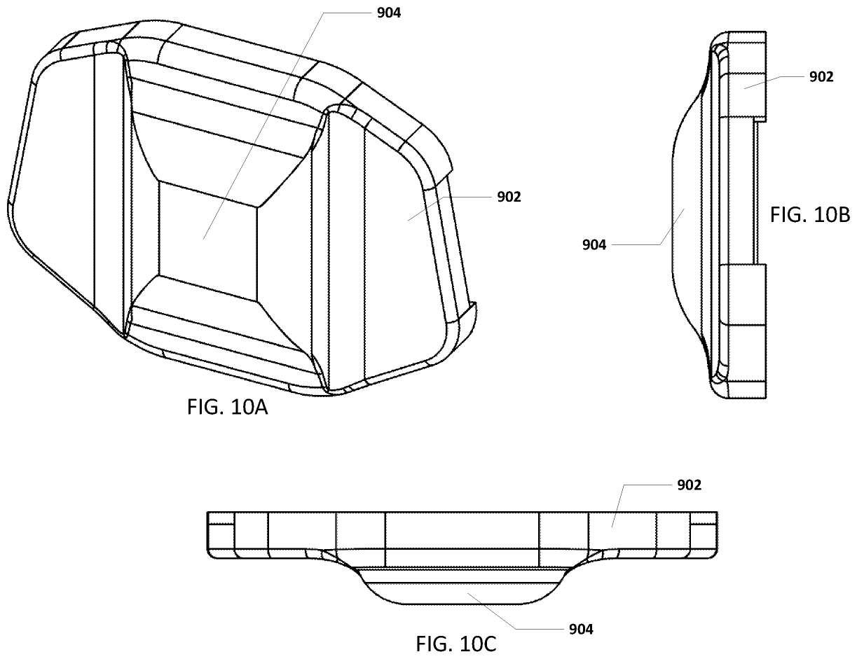

FIGS. 10A-C show different views of another embodiment of the foam platform and protuberance.

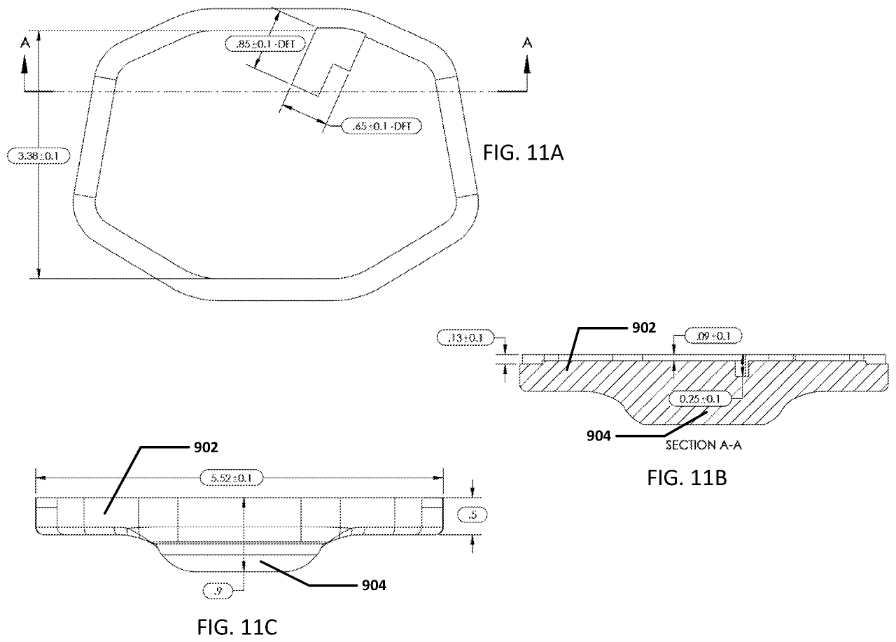

FIGS. 11A-C show different views of another embodiment of the foam platform and protuberance, along with some example dimensions in inches.

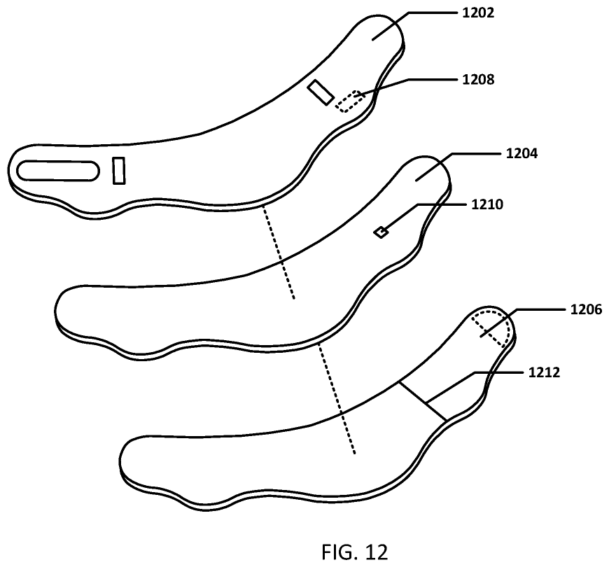

FIG. 12 shows an embodiment of the belt of the device. The belt shape and construction is meant to maximize patient comfort while providing transmission of vibration from the pack to the patient. A parabolic contour may be used so that the best is more form fitting. When the belt is worn, it fits snugly around the waist and wider over the hips. In addition, this contour facilitates correct placement of the belt.

The belt itself may be comprised of several layers of neoprene, to which various fasteners, stays (nylon webbing loops), a zipper, and pockets may be added. Each layer of neoprene may have a thin nylon fabric laminated on either side. The middle structural layer 1204, which may be about 3 mm thick, supports most of the weight of the vibration pack and provides some rigidity. The outer and inner layers, 1202 and 1206, of neoprene may be about 1 mm thick. During assembly, the layers may be stacked and then the edges may be bound together with a thin nylon strip. Neoprene and nylon may be used due to their elasticity, so that the belt optimally conforms to various anatomies, and established use in skin-contacting apparel and athletic products. Patients may be instructed to wear the belt over a layer of clothing. Also shown in FIG. 12 are accelerometer pocket 1210, invisible zipper opening 1212 and user interface board pocket 1208. The user interface board may include an on/off button, a battery level indicator, and an alarm indicator, which may be used for various parameters such as fit, treatment time, treatment level, treatment limit etc.

Final assembly of the belt may be completed using the access zipper 1212 on the back side. The vibration pack may be rigidly fixed to the middle structural layer by compressing the middle layer between the vibration pack and a metal plate. When assembly is complete, the zipper may be locked in place to prevent access to components and wiring.

Belt dimensions for the three sizes were chosen based on average female dimensions in the US. The mean hip size for women in our target population, from ages 46-66+, is approximately 44″, with standard deviation of about 4.5″. Therefore, assuming a normal distribution, the device size range (across three sizes) of 35″-54″ should accommodate approximately 95% of the US female population.

The vibration pack may generate vibration using a powered eccentric-rotating-mass motor controlled by pulse-width modulation (PWM). The duty cycle of the motor PWM can be changed to tune rotation frequency, which also changes vibration amplitude (motor frequency and vibration amplitude are approximately linearly proportional over the motor frequency range of 15-50 Hz). The motor may be attached to, and oriented within, the pack to transmit vibration to the patient, with the vibration primarily being in the sagittal plane (x- and z-axes, where the z-axis is parallel to the patient's height axis/long body axis).

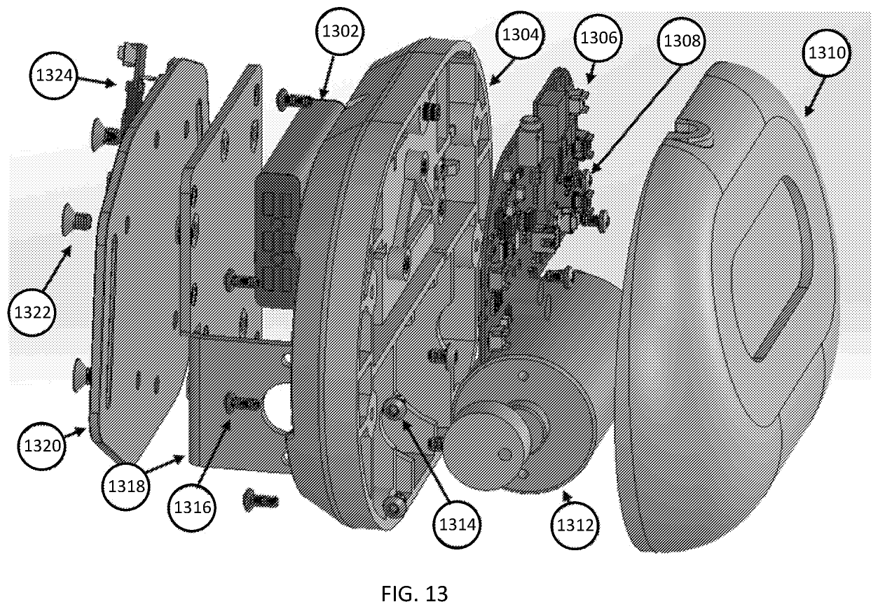

FIG. 13 shows an embodiment of the vibration pack. Shown are battery 1302, bottom half of housing 1304, printed circuit board assembly (PCBA) 1306, screws 1308, top half of housing 1310, motor 1312, screws 1314, screws 1316, motor mount plate 1318, back plate 1320, belt attachment screws 1322, pressure, or force sensor 1324. The housing may comprise be made of ABS (Acrylonitrile Butadiene Styrene Plastic) housing. The plates may be 0.1″ aluminum plates.

The vibration pack is mounted to the belt via back plate 1320. The neoprene of the belt is sandwiched between back plate 1320 and motor mount plate 1318 using six screws.

The contact surface between the vibration pack and the patient (between the back plate above and the patient) may be padded by a piece of 0.5″ dense polyethylene foam. The foam serves the purpose of making the belt more comfortable as well as ensuring better contact (more surface area) between the vibration pack's force sensor and the patient's body. In addition, the foam serves as a landmark on the belt for correct placement over the patient's sacrum. The foam is dense enough that it does not significantly attenuate vibration transmitted to the body, which is important for achieving the target therapeutic level.

The vibration pack shown also contains a PCBA, which has device control hardware including a microprocessor, real time clock (RTC), motor control chip, battery charge chip, an accelerometer, flash memory chip, and a Bluetooth Low Energy (BLE) module, in addition to supporting hardware (voltage regulators, operational amplifiers, etc). Motor performance is monitored by an on-board motor control chip, including safety features such as a current sensor (which electronically reduces the motor speed if the current draw is higher than permitted). As a backup safety mechanism, the board has hardware fuse which trips if the current draw exceeds 2.2 A, thereby shutting down the device.

Vibrational energy may be at a frequency of about 30-90 cycles per second (Hz). Other frequency ranges are also contemplated such as 1-100 HZ and other sub-ranges therein, such as, 25-35 Hz, or 20-40 Hz, or 10-50 Hz, including specific frequencies therein, such as about 30 Hz, or about 20 Hz, or about 10 Hz or about 4 Hz. The intensity can range from 0.01 g to 10 g (where 1.0 g=earth's gravitational field=9.8 m/s/s), and other sub-ranges therein, such as 0.01 g to 4.0 g, and specific magnitudes therein, such as about 0.3 g or about 1.0 g.

The vibration device may have several sensors to monitor device usage and performance. An accelerometer may be embedded within the neoprene belt approximately over where the patient's right iliac crest is located while worn. This accelerometer may be used to quantify transmission of acceleration from the pack to the patient, and the motor speed may be adjusted to ensure that the transmitted vibration magnitude is within the range of what is safe and therapeutic. A second accelerometer may be located on the PCBA proximal to the motor, where it may be used to monitor motor activity directly. The accelerometers may utilize MEMS (Micro-Electro-Mechanical Systems) technology, making them extremely small and reliable. The digital sensors may have a maximum range of ±16 g (although this range is set to ±4 g in practice to increase sensitivity) and may be capable of high resolution data rates up to 1.6 kHz.

To ensure adequate belt tightness for proper transmission of the vibration to the patient, a force, or pressure sensor may be is located at the interface between the patient and the pack (in this embodiment it is located behind the foam padding) to monitor pack force against the sacrum. If the belt tightness is insufficient before turning on the motor or if the belt tightness drops below a threshold during use, the motor may not turn on or stop during use, respectively.

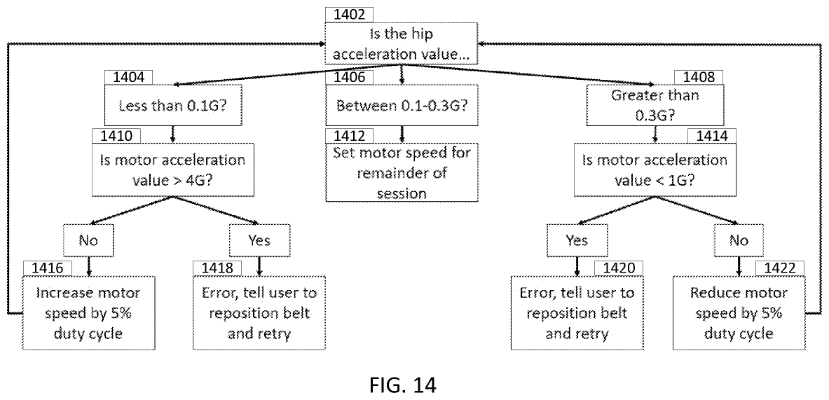

The vibration device may have an “auto-calibration” feature to ensure that the patient is receiving a safe and therapeutic level of vibration with each use. A feedback loop can read the value of the belt-mounted accelerometer, identify if the reading is within a specified window, and either increase or decrease the power supplied to the motor until the belt-mounted accelerometer reads within the specified window. A control logic of some embodiments is represented by the flowchart in FIG. 14.

As shown in FIG. 14, the controller can manage cases where the hip accelerometer reading is artificially low (for example, in the case where the belt is not worn on the body) or artificially high (for example, if the patient is jumping up and down). The controller checks whether the hip accelerometer value is consistent with an expected motor accelerometer value before continuing to adjust the motor power. Box 1402 represents the controller checking the acceleration sensed by an accelerometer at the hip. If the value is below a threshold, for example, 0.1 g, as shown in box 1404, the controller checks the motor acceleration at box 1410.

If the motor acceleration is above a threshold, for example, 4 g, the controller will issue an error instructing the user to reposition the device and try again, as represented by box 1418. If the motor acceleration is below a threshold, for example 4 g, the controller may increase the motor speed, for example, by 5% of the duty cycle, as shown at box 1416.

If the acceleration at the hip is above a threshold, for example 0.3 g, as is represented by box 1408, the controller may check the motor acceleration, as represented by box 1414. If the motor acceleration is below a threshold, for example 1 g, the controller will issue an error to the user, instructing the user to reposition the device and try again, as represented by box 1420. If the motor acceleration is above a threshold, for example 1 g, the controller may reduce the motor speed, for example by 5% of the duty cycle, as shown at box 1422.

If the acceleration measured at the hip is between two threshold levels, for example, 0.1 g and 0.3 g, as represented by box 1406, the controller will maintain the speed of the motor, as shown at box 1412.

If the belt and motor readings are inconsistent with each other (ratio of acceleration values (motor:belt) is below 2.0 or above 25.0), the system will not proceed to the treatment and will provide instructions to reposition the belt and to stand still during the short calibration process. In addition, to mitigate the effects of noisy accelerometer data caused by patient movement during the calibration process, it is possible to filter the data in real-time to obtain the most accurate readings. If the hip accelerometer readings (before calibration) are outside of the specified ranges over successive uses (indicating inconsistent application of the device/noncompliance with device instructions), the device can alert the patient to seek additional training/technical support.

The patient may control the device through a simple user interface (UI) on the front of the belt or in a remote controller such as a mobile phone, computer, or tablet. For example, a power button may be used to switch the device on and off. Two light-emitting diodes (LEDs) may indicate normal operation and notify the patient of any suggested actions (tighten the belt, charge the device, etc.) or of any device-related issues, in which case they would contact technical support. In addition, a speaker in the vibration pack allows for audible notification of any status updates requiring the patient's attention.

The vibration device maybe designed to mitigate potential safety risks and ensure effectiveness by incorporating the following features:

Sensor for proper belt fit. On the patient-side of the pack, a force or pressure sensor may be positioned between the pack and the foam, or elsewhere. This force sensor ensures that the belt is tight enough for effective vibration transmission to the patient yet not overly tight as to create discomfort while wearing the device. The optimal range for belt-fit force sensor reading may be between 12.2 N and 20 N. If this range is used, the force reading must be within this range before the device motor starts to initiate a treatment session. While treatment is being administered, if the force reading falls outside of this range for over 30 seconds, the motor will stop and the belt tightness must be adjusted back within the range to continue treatment.

Automatic shut-off at the end of a treatment session. The vibration device ma have an internal timer that automatically turns off the motor after 18 minutes (or other set time, such as 20 minutes, or 30 minutes) of treatment has been administered. This ensures that the patient receives the correct daily treatment without over-exposure to vibration.

Overuse prevention. To further ensure that a patient does not self-administer treatments too frequently, which could provide over-exposure to vibration, the vibration device controller may restricts the total treatment duration to 18 minutes (or other set time) per calendar day. If a patient manually forces the device off before the set treatment session time has completed or if the force sensor reading goes out of range during treatment and the device shuts off automatically, the patient will can start another treatment on the same calendar day, but the device may automatically shut off when 18 total cumulative minutes of treatment is reached for that day.

Automatic tuning of the vibration magnitude at the start of each treatment session. While features may be designed into the vibration device to standardize vibration transmitted from the motor to the patient, multiple patient factors may affect this transmission. These factors include patient anatomical parameters that vary between individuals and within an individual over time, such as body shape, size, composition, and weight, as well as belt application variability from day-to-day that could impact belt tightness. To ensure that the vibration dose administered to the patient is consistent and both safe and effective/therapeutic for the intended use, the applied vibration may be tuned at the beginning of each treatment session. Vibration dose can be altered via modifying the motor frequency (for example, within a range of 20-40 Hz). Vibration dose may be measured with the belt accelerometer, which is located at the patient's right iliac crest. When the patient puts the vibration device on, the motor may begin at the frequency of the previous session, and the controller may determine the vibration magnitude. If the measured vibration magnitude is outside of the specified range (for example, 0.03-0.10 g, RMS (root mean square)), the frequency is increased or decreased by an increment, such as 5 Hz, as appropriate and the vibration magnitude is measured again. This continues until the measured vibration magnitude is within the specified range. If the limit of the frequency range is met without reaching the specified range, the device shuts off and the device warning light blinks to direct the patient to the Instructions for Use for troubleshooting guidance.

Maximum Daily Safe Exposure Level. ISO 2631-1 provides guidelines for safe levels of vibration transmitted through the body via the supporting structure when the individual is standing or sitting for 4-8 hr/day (e.g. heavy machine operators, factory workers). ISO 2631-1 also includes guidelines for extrapolating to shorter periods of exposure and alternate ways that the vibration is applied.

ISO 2631-1 (herein incorporated by reference in its entirety) provides guidelines for calculating a value for the equivalent vibration exposure, which is dependent on multiple factors, including the applied acceleration magnitude in three orthogonal directions, the frequency of the vibration, and the subject's body position during exposure.

Maximum Daily Safe Exposure Level

The maximum daily safe exposure level is calculated based on both treatment time, and frequency level of the motor. To remain under the maximum safe exposures, the controller of the vibration device may limit the time and frequency that the user is exposed to during any 24 hour period. In other words, the controller of the vibration device may limit the cumulative vibration exposure of an individual in a 24 hour period to make sure it is under the recommended maximum vibration exposure, given all the relevant parameters. To achieve this, the controller may take into consideration the frequency of the motor, and set a maximum 24 hour cumulative exposure time. Or, the controller may simply limit the cumulative exposure time within any 24 hour period to around 18 minutes, around 20 minutes or around 30 minutes. The controller may limit the exposure by not allowing the device to function during a 24 hour period once the limit has been reached. Alternatively or additionally, the device may alert the user that the limit has been reached. The device would function again after the 24 hour period. Possible cumulative time limits may be around 15-20 minutes, 20-30 minutes, 30-40 minutes, 40-60 minutes etc. The frequency of the motor may or may not be taken into consideration in the determination of these limits. Other factors that may be taken into consideration, and may be entered into the controller of the system, include: parameters sensed by any sensors on the system, including accelerometers, pressure or force sensors, etc. For example, if the vibrational exposure for 30 minutes were 0.330 g RMS (peak to peak×0.7 approx. for sinusoidal signals), the vibration device could be tuned (by using sensor info) to deliver around 0.1-0.3 g peak to peak vibration. Alternatively, the sensors may be monitored to determine the delivered vibration, and the controller may limit the exposure time accordingly.

Example of Data Processing System

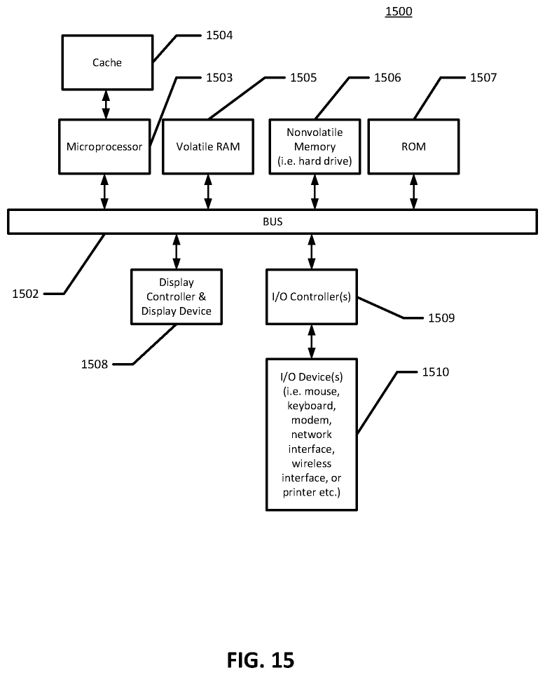

FIG. 15 is a block diagram of a data processing system, which may be used with any embodiment of the invention. For example, the system 1500 may be used as part of the processor. Note that while FIG. 15 illustrates various components of a computer system, it is not intended to represent any particular architecture or manner of interconnecting the components; as such details are not germane to the present invention. It will also be appreciated that network computers, handheld computers, mobile devices, tablets, cell phones and other data processing systems which have fewer components or perhaps more components may also be used with the present invention.

As shown in FIG. 15, the computer system 1500, which is a form of a data processing system, includes a bus or interconnect 1502 which is coupled to one or more microprocessors 1503 and a ROM 1507, a volatile RAM 1505, and a non-volatile memory 1506. The microprocessor 1503 is coupled to cache memory 1504. The bus 1502 interconnects these various components together and also interconnects these components 1503, 1507, 1505, and 1506 to a display controller and display device 1508, as well as to input/output (I/O) devices 1510, which may be mice, keyboards, modems, network interfaces, printers, and other devices which are well-known in the art.

Typically, the input/output devices 1510 are coupled to the system through input/output controllers 1509. The volatile RAM 1505 is typically implemented as dynamic RAM (DRAM) which requires power continuously in order to refresh or maintain the data in the memory. The non-volatile memory 1506 is typically a magnetic hard drive, a magnetic optical drive, an optical drive, or a DVD RAM or other type of memory system which maintains data even after power is removed from the system. Typically, the non-volatile memory will also be a random access memory, although this is not required.

While FIG. 15 shows that the non-volatile memory is a local device coupled directly to the rest of the components in the data processing system, the present invention may utilize a non-volatile memory which is remote from the system; such as, a network storage device which is coupled to the data processing system through a network interface such as a modem or Ethernet interface. The bus 1502 may include one or more buses connected to each other through various bridges, controllers, and/or adapters, as is well-known in the art. In one embodiment, the I/O controller 1509 includes a USB (Universal Serial Bus) adapter for controlling USB peripherals. Alternatively, I/O controller 1509 may include IEEE-1394 adapter, also known as FireWire adapter, for controlling FireWire devices, SPI (serial peripheral interface), I2C (inter-integrated circuit) or UART (universal asynchronous receiver/transmitter), or any other suitable technology. Wireless communication protocols may include Wi-Fi, Bluetooth, ZigBee, near-field, cellular and other protocols.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Any of the features of any of the embodiments disclosed herein may be used with other embodiments.

What is claimed is:

1. A vibration apparatus for treating a subject, comprising:
an actuator configured to generate vibrational energy;
a securing mechanism for positioning the actuator upon the body of the subject while maintaining portability such that the vibrational energy generated by the actuator is directed into an area of the body of the subject to be treated;
a controller in communication with the actuator, wherein the controller is programmed to determine an exposure level of the vibrational energy to the area of the body for comparison against a maximum exposure level such that the exposure level is limited by the maximum exposure level within a predetermined period of time.

2. The apparatus of claim 1 wherein the actuator comprises a motor configured to generate mechanical vibrational energy.

3. The apparatus of claim 1 wherein the maximum exposure level comprises a treatment time of 30 minutes within a 24 hour predetermined period of time.

4. The apparatus of claim 1 wherein the maximum exposure level comprises a treatment time of 20 minutes within a 24 hour predetermined period of time.

5. The apparatus of claim 1 wherein the maximum exposure level comprises a treatment time of between 20 to 30 minutes within a 24 hour predetermined period of time.

6. The apparatus of claim 1 wherein the maximum exposure level comprises a treatment time of between 30 to 40 minutes within a 24 hour predetermined period of time.

7. The apparatus of claim 1 wherein the controller is configured to obtain a frequency of the actuator in determining a treatment time.

8. The apparatus of claim 1 further comprising an accelerometer in communication with the controller.

9. The apparatus of claim 8 wherein the controller is configured to receive a signal via the accelerometer in determining a treatment time.

10. The apparatus of claim 1 further comprising a pressure senor in communication with the controller and configured to be in contact with the area of the body of the subject to be treated.

11. The apparatus of claim 10 is configured to receive a pressure signal via the pressure sensor in determining a treatment time.

12. The apparatus of claim 1 wherein the securing mechanism is configured to position the actuator upon the body such that the vibrational energy is directed into at least one bone of the subject to be treated.

13. A vibration apparatus for treating a subject, comprising:
an actuator configured to generate vibrational energy;
a securing mechanism for positioning the actuator upon the body of the subject while maintaining portability such that the vibrational energy generated by the actuator is directed into an area of the body of the subject to be treated;
a first accelerometer positioned in proximity to the area of the body of the subject and configured to detect a resultant vibrational energy transmitted into the area of the body of the subject; and
a controller in communication with the actuator and the first accelerometer, wherein the controller is programmed to receive a signal indicative of the resultant vibrational energy from the first accelerometer and automatically calibrate the actuator to adjust the generated vibrational energy until the resultant vibrational energy is within a predetermined range.

14. The apparatus of claim 13 wherein the first accelerometer is positioned upon the securing mechanism.

15. The apparatus of claim 13 wherein the apparatus is configured to position the first accelerometer at or in proximity to a hip of the subject when secured to the body of the subject.

16. The apparatus of claim 13 wherein the controller is further programmed to provide an alert for repositioning of the apparatus relative to the body of the subject or increase the vibrational energy when the resultant vibrational energy is below a first lower threshold level.

17. The apparatus of claim 16 wherein the first lower threshold level is 0.1 g.

18. The apparatus of claim 16 further comprising a second accelerometer in communication with the actuator and configured to detect the vibrational energy from the actuator.

19. The apparatus of claim 18 wherein the controller is further programmed to increase the vibrational energy from the actuator when the vibrational energy detected by the second accelerometer is below a second upper threshold level.

20. The apparatus of claim 19 wherein the controller is further programmed to provide an alert for repositioning of the apparatus relative to the body of the subject when the vibrational energy detected by the second accelerometer is above the second upper threshold level.

21. The apparatus of claim 13 wherein the controller is further programmed to provide an alert for repositioning of the apparatus relative to the body of the subject or decrease the vibrational energy when the resultant vibrational energy is above a first upper threshold level.

22. The apparatus of claim 21 wherein the first upper threshold level is 0.3 g.

23. The apparatus of claim 22 further comprising a second accelerometer in communication with the actuator and configured to detect the vibrational energy from the actuator.

24. The apparatus of claim 23 wherein the controller is further programmed to decrease the vibrational energy from the actuator when the vibrational energy is above a second lower threshold level.

25. The apparatus of claim 23 wherein the controller is further programmed to provide an alert for repositioning of the apparatus relative to the body of the subject when the vibrational energy is below a second lower threshold level.

26. The apparatus of claim 13 wherein the securing mechanism is configured to position the actuator upon the body such that the vibrational energy is directed into at least one bone of the subject to be treated.

27. A method for treating a subject, comprising:
generating vibrational energy from an actuator such that the vibrational energy is directed into an area of a body of the subject while maintaining portability of the actuator;
monitoring the vibrational energy transmitted into the area of the body via a controller;
determining an exposure level via the controller of the vibrational energy transmitted into the area of the body for comparison against a maximum exposure level such that the exposure level is limited by the maximum exposure level within a predetermined period of time; and
transmitting the vibrational energy into the area of the body to be within the maximum exposure level.

28. The method of claim 27 wherein generating vibrational energy from the actuator comprises generating the vibrational energy via a motor.

29. The method of claim 27 wherein transmitting the vibrational energy comprises transmitting the vibrational energy over a treatment time of 30 minutes within a 24 hour predetermined period of time.

30. The method of claim 27 wherein transmitting the vibrational energy comprises transmitting the vibrational energy over a treatment time of 20 minutes within a 24 hour predetermined period of time.

31. The method of claim 27 wherein transmitting the vibrational energy comprises transmitting the vibrational energy over a treatment time of between 20 to 30 minutes within a 24 hour predetermined period of time.

32. The method of claim 27 wherein transmitting the vibrational energy comprises transmitting the vibrational energy over a treatment time of between 30 to 40 minutes within a 24 hour predetermined period of time.

33. The method of claim 27 wherein determining the exposure level comprises obtaining a treatment time and a frequency of the actuator in determining the exposure level.

34. The method of claim 27 wherein monitoring the vibrational energy comprises monitoring via an accelerometer in communication with the controller and the actuator.

35. The method of claim 34 further comprising receiving a frequency signal via the accelerometer in determining the exposure level.

36. The method of claim 34 further comprising receiving a pressure signal from a pressure senor in communication with the controller and configured to be in contact with the area of the body of the subject to be treated.

37. The method of claim 36 wherein controller is configured to receive the pressure signal via the pressure sensor in determining a treatment time.

38. The method of claim 27 wherein transmitting the vibrational energy comprises transmitting the vibrational energy into at least one bone of the body of the subject.

39. The method of claim 27 further comprising providing an indication when the exposure level reaches the maximum exposure level.

40. A method for treating a subject, comprising:
generating vibrational energy from an actuator such that the vibrational energy is directed into an area of a body of the subject while maintaining portability of the actuator;
monitoring a resultant vibrational energy transmitted into the area of the body of the subject via a first accelerometer positioned in proximity to the area of the body, wherein the first accelerometer and the actuator are in communication with a controller; and
automatically calibrating the actuator via the controller by adjusting the vibrational energy until the resultant vibrational energy is within a predetermined range.

41. The method of claim 40 wherein monitoring the resultant vibrational energy comprises monitoring via the first accelerometer positioned at or in proximity to a hip of the subject when secured to the body of the subject.

42. The method of claim 40 further comprising providing an alert for repositioning of the apparatus relative to the body of the subject or increase the vibrational energy when the resultant vibrational energy is below a first lower threshold level.

43. The method of claim 42 wherein the first lower threshold level is 0.1 g.

44. The method of claim 40 further comprising monitoring the vibrational energy via a second accelerometer in communication with the actuator.

45. The method of claim 44 wherein automatically calibrating the actuator comprises increasing the vibrational energy from the actuator when the vibrational energy detected by the second accelerometer is below a second upper threshold level.

46. The method of claim 45 further comprising providing an alert for repositioning of the apparatus relative to the body of the subject when the vibrational energy detected by the second accelerometer is above the second upper threshold level.

47. The method of claim 40 further comprising providing an alert for repositioning of the apparatus relative to the body of the subject or decrease the vibrational energy when the resultant vibrational energy is above a first upper threshold level.

48. The method of claim 47 wherein the first upper threshold level is 0.3 g.

49. The method of claim 40 wherein automatically calibrating the actuator comprises decreasing the vibrational energy from the actuator when the vibrational energy is above a second lower threshold level.

50. The method of claim 40 further comprising providing an alert for repositioning of the apparatus relative to the body of the subject when the vibrational energy is below a second lower threshold level.

51. The method of claim 40 further comprising transmitting the vibrational energy into at least one bone of the body of the subject to be treated.
